(19) United States
(12) Patent Application Publication
(10) Pub. No.: US 2026/0097420 A1
(43) Pub. Date: Apr. 9, 2026

(54) AUTOMATED INSPECTION SYSTEM AND METHOD

(71) Applicant: TOPCON POSITIONING SYSTEMS, INC., Livermore, CA (US)

(72) Inventors: Raad A. DAWOOD, Bayside, WI (US); Andres GOMEZ GARCIA, Livermore, CA (US); Siamak HEZARJARIBI, San Jose, CA (US)

(73) Assignee: TOPCON POSITIONING SYSTEMS, INC., Livermore, CA (US)

(21) Appl. No.: 18/908,743

(22) Filed: Oct. 7, 2024

(51) Int. Cl. B07C 5/342; G01N 21/88

(52) U.S. Cl. CPC B07C 5/3422; G01N 21/8851; B07C 2501/0063; G01N 2021/8854; G01N 2021/8887

(57) ABSTRACT

An automated inspection method removes a tray of objects from a mobile shelf rack using a robotic arm. The tray is placed in an inspection field of a plurality of cameras. The tray is placed in a first location in response to determining that the object is acceptable. The tray is placed in a second location in response to determining that the object is not acceptable.

### FIELD OF THE INVENTION

The present disclosure relates generally to object inspection, and more particularly to an automated inspection system and method.

### BACKGROUND

Objects, such as manufactured parts, typically require inspection. Manual inspection of parts can result in inspection errors. For example, the repetitive nature of inspections can cause a person to become bored, and this boredom can lead to inspection errors. The human errors introduced by boredom inducing repetitive tasks can be eliminated by automating inspections. Automated inspection can result in higher quality control but equipment for automated inspection is typically single purpose and can only be used to inspect specific parts at a high throughput. What is needed is an automated inspection system that can be easily modified to be used with different types of objects and has a high throughput.

### SUMMARY

A method for automatic inspection of objects includes the step of removing a tray holding an object from a mobile shelf rack using a robotic arm. The robotic arm maneuvers the tray so that the object is placed in an inspection field of a plurality of cameras. The object in the inspection field is then inspected using the plurality of cameras. The tray is placed in a first location by the robotic arm in response to the inspecting determining that the object is acceptable and placed in a second tray in response to the inspecting determining that the object is not acceptable. Placing the tray in the first location can comprise placing the tray in a mobile shelf rack for holding trays holding acceptable objects and placing the tray in the second location can comprise placing the tray in a mobile shelf rack for holding trays holding unacceptable objects. In one embodiment, the object is inspected to check one or more of object specifications, tolerances, or blemishes. In one embodiment, a gripper of the robotic arm grips the tray before maneuvering it. In one embodiment, the inspecting can comprise capturing images of the object in the inspection field using five cameras arranged so that their fields of view form a contiguous inspection field. The inspecting can comprise capturing a top view of the objects located in the inspection field using one of the plurality of cameras located above the inspection field. The inspecting can comprise capturing side views of the object located in the inspection field using four of the plurality of cameras located to face the sides of the object. In one embodiment, the inspecting the object comprises analyzing the object using artificial intelligence. The artificial intelligence can analyze the object based on image captured by the plurality of cameras.

An automatic inspection system is also described herein having a robotic arm configured to grip and maneuver a tray, a plurality of cameras, an incoming mobile shelf rack configured to hold a plurality of trays, and a controller. The controller is configured to control the automated inspection system to perform operations including removing a first tray from the incoming mobile shelf rack using the robotic arm, maneuvering the first tray such that an object on the first tray is in an inspection field of the plurality of cameras, inspecting the object in the inspection field, placing the first tray in a first location in response to the inspecting determining that the object is acceptable, and placing the first tray in a second location in response to the inspecting determining that the object is not acceptable. In one embodiment, the automatic inspection system further comprises a rejected object tray and an object vacuum removal system configured to remove one or more objects in a tray and place the objects in the rejected object tray. The controller can be configured to cause the object vacuum removal system to remove the one or more objects and place the one or more removed objects in the rejected object tray prior to placing the first tray in a first location. The plurality of cameras can be arranged so that their fields of view form a contiguous inspection field. The controller can be configured to inspect the object using artificial intelligence. In one embodiment, the robotic arm has a gripper configured to grip the first tray and the gripper has a jaw configured to engage a slot of a tray.

### BRIEF DESCRIPTION OF THE DRAWINGS

FIG. 1 shows an automatic inspection system according to one embodiment;

FIGS. 2A and 2B show different views of a robot base according to one embodiment;

FIGS. 3A through 3D show a robotic arm according to one embodiment;

FIGS. 4A through 4E show a tray being removed from a mobile shelf rack according to one embodiment;

FIGS. 5A through 5C show cameras arranged to have their fields of view form an inspection field;

FIGS. 6A through 6C show details of a mobile shelf rack according to one embodiment;

FIGS. 7A through 7C show a rejected object shelf according to one embodiment;

FIG. 8 shows an object vacuum removal system according to one embodiment;

FIGS. 9A through 9D show removal of an object from a tray according to one embodiment;

FIGS. 10A through 10C show a tray for holding small sized objects according to one embodiment;

FIGS. 11A through 11C show a tray for holding medium sized objects according to one embodiment;

FIGS. 12A through 12D shows a tray for holding large sized objects according to one embodiment;

FIG. 13 shows a method for automatic inspection according to one embodiment;

FIG. 14 shows a high-level schematic of a computer for implementing methods and systems described herein;

### DETAILED DESCRIPTION

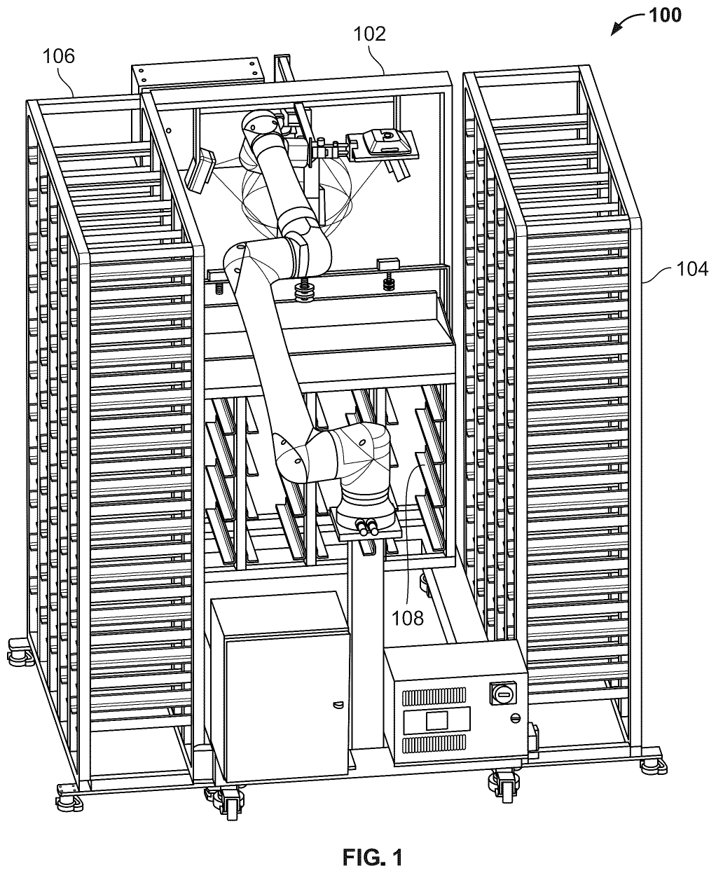

FIG. 1 shows an automatic inspection system 100 that is configured to automatically inspect objects, such as parts, to determine if the objects are acceptable according to particular inspection criteria such as object/part specifications, tolerances, blemishes, etc. According to one embodiment, automatic inspection system 100 comprises robot base 102, incoming mobile shelf rack 104 configured to hold trays (not shown) having objects for inspection, passed inspection mobile shelf rack 106 configured to hold trays having objects that have been inspected and passed inspection, and failed inspection shelves 108. Robot base 102 has components for removing each tray of objects from incoming mobile shelf rack 104 and inspecting the objects on the removed tray. If the objects are acceptable, the removed tray is then placed on passed inspection mobile shelf rack 106. If objects on the removed tray fail inspection, the tray can be placed on a shelf of failed inspection shelves 108. The automatic inspection system is versatile and can inspect a variety of objects and various configurations of objects located in trays. The components of robot base 102 are described as follows.

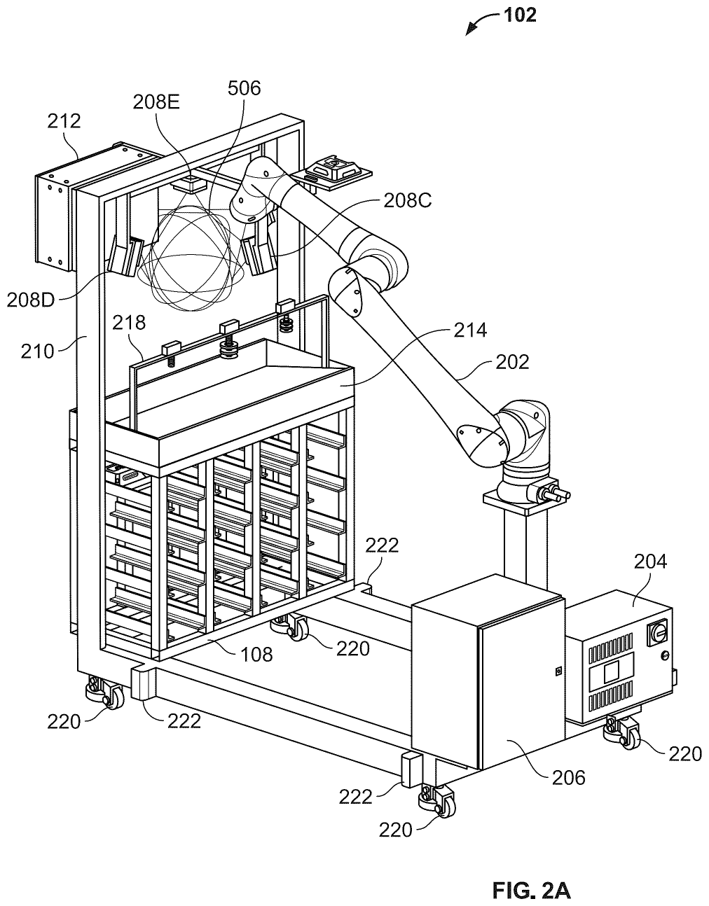

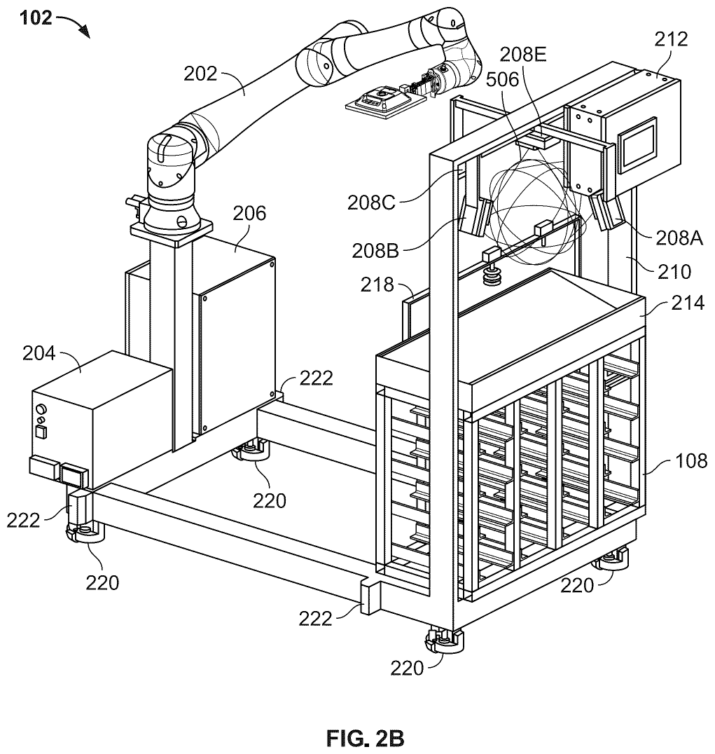

FIGS. 2A and 2B show robot base 102 from different angles in order to show all components of robot base 102. Robot base 102 includes frame 210 to which multiple components are mounted. Robotic arm 202 is mounted to frame 210 and is commanded by controller 204 to maneuver trays, and therefore objects located on the trays, to a variety of locations. A plurality of cameras 208A-208E are mounted to an upper portion of frame 210 along with human-machine interface (HMI) 212. The visual range of each of plurality of cameras 208A-208E overlap to form inspection field 506 (described in further detail below). Rejected object tray 214 is located below plurality of cameras 208A-208E and HMI 212. Failed inspection shelves 108 are located below rejected object tray 214. Object vacuum removal system 218 is located above rejected object tray 214. Electrical enclosure 206 powers electrical devices including robotic arm 202, controller 204, HMI 212, plurality of cameras 208A-208E, and object vacuum removal system 218. Frame 210 sits on casters 220 and has mobile shelf rack latching mechanisms 222 on opposing sides for locking mobile shelf racks 104 and 106 to frame 210.

In one embodiment, controller 204 operates automatic inspection system 100 described here in conjunction with FIGS. 1, 2A, and 2B. Controller 204 operates automatic inspection system 100 in accordance with programming that can be entered via HMI 212 to inspect objects located in trays placed in incoming mobile shelf rack 106. Robotic arm 202 removes a tray from incoming mobile shelf rack 106 and positions the objects on the tray in view of plurality of cameras 208A-208E. Images of the objects in the tray are captured by plurality of cameras 208A-208E and those images are analyzed by controller 204. If the objects are acceptable, the tray is placed in passed inspection mobile shelf rack 106. If the objects are not acceptable, the tray is placed in failed inspection shelves 108. If one of a plurality of objects on a tray is not acceptable, the unacceptable object can be removed from the tray by object vacuum removal system 218 and placed in rejected object tray 214. The tray with remaining acceptable objects can be placed in passed inspection mobile shelf rack 106.

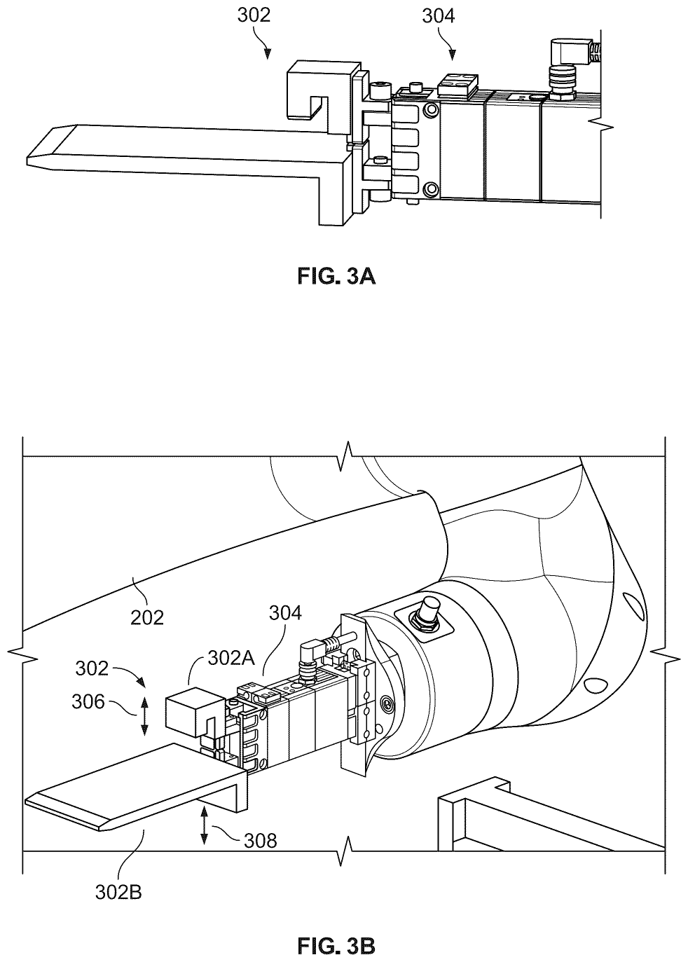

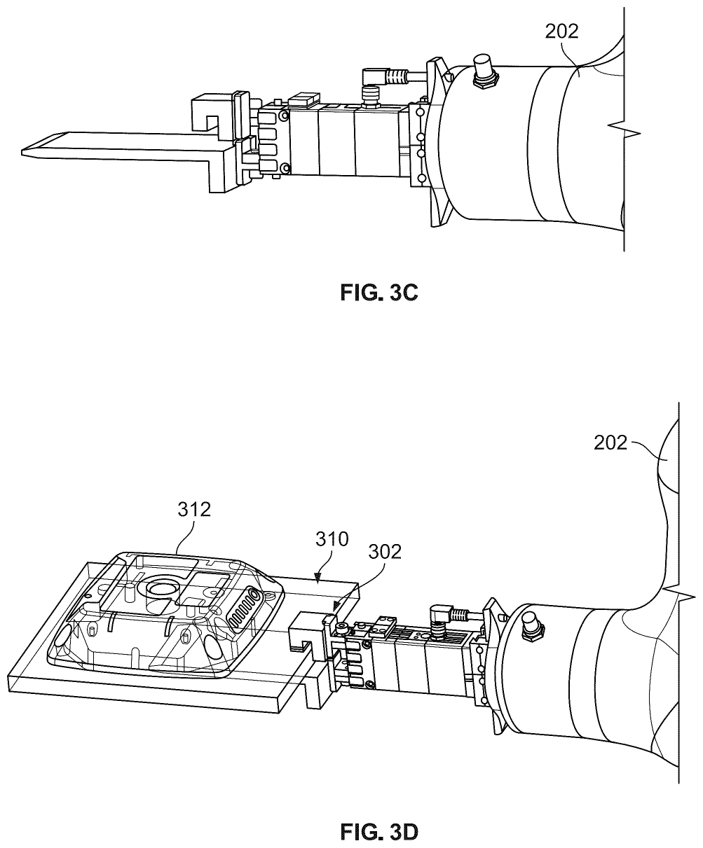

FIG. 3A shows a free end of robotic arm (not shown in FIG. 3A) having electric gripper 302 that is configured to engage with trays holding one or more objects. The free end of robotic arm 202 also has presence sensor 304 for detecting the presence of a tray. FIG. 3B shows electric gripper 302 having a first jaw 302A which has an inverted “J” shape and a second jaw 302B having an “L” shape. First jaw 302A is configured to engage with a slot located in each of the trays (described in detail below). Second jaw 302B is configured to support a tray and has a long axis that distributes the weight of the tray along that long axis. FIG. 3B shows electric gripper 302 in an open position that allows a tray to be located between first gripper plate 302A and second gripper plate 302B. Double headed arrows 306 and 308 show the possible directions of movement of gripper plates 302A and 302B with respect to each other. FIG. 3C shows electric gripper in a closed position which allows a tray to be gripped. FIG. 3D shows tray 310 holding large object 312 being gripped by electric gripper 302. Presence sensor 304 can be located in various positions to detect the presence of a tray. For example, in one embodiment, presence sensor 304 can be embedded in an end of first jaw 302A so that when electric gripper 302 is maneuvered to engage a tray, presence sensor 304 detects the presence of the tray located between first gripper plate 302A and second gripper plate 302B. Presence sensor can be configured to detect metallic and non-metallic trays and can be an optical sensor, capacitive sensor, mechanical switch, or any other type of sensor that can detect trays.

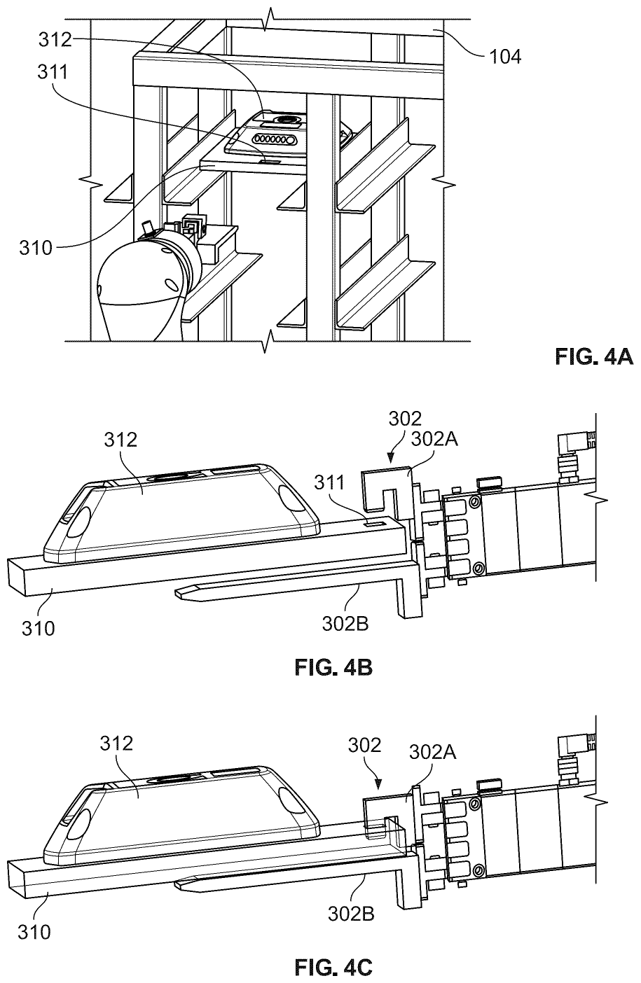

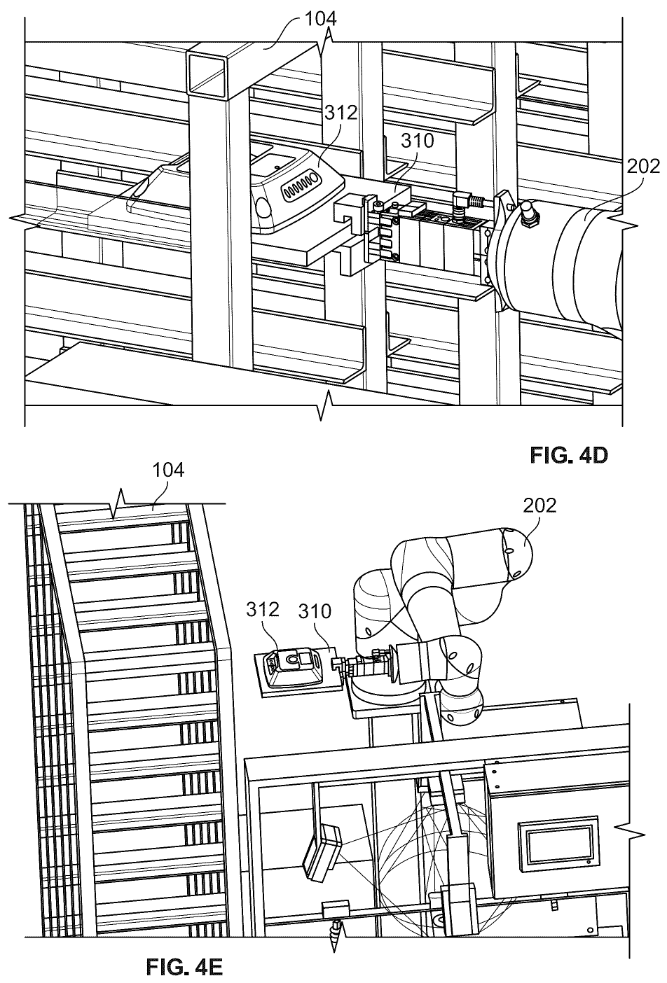

FIGS. 4A through 4E show how tray 310 holding large object 312 is removed from incoming mobile shelf rack 104. FIG. 4A shows tray 310, having slot 311, located on incoming mobile shelf rack 104. FIG. 4B shows electric gripper 302 moving into a position to grip tray 310 with second gripper plate 302B being slid under tray 310. First gripper plate 302A is moved into slot 311 (e.g., a pocket) of tray 310. FIG. 4C shows electric gripper 302 clamped on and secured to tray 310. FIG. 4D shows tray 310 being removed from incoming mobile shelf rack 104 by robotic arm 202. FIG. 4E shows tray 310 fully removed from incoming mobile shelf rack 104 by robotic arm 202.

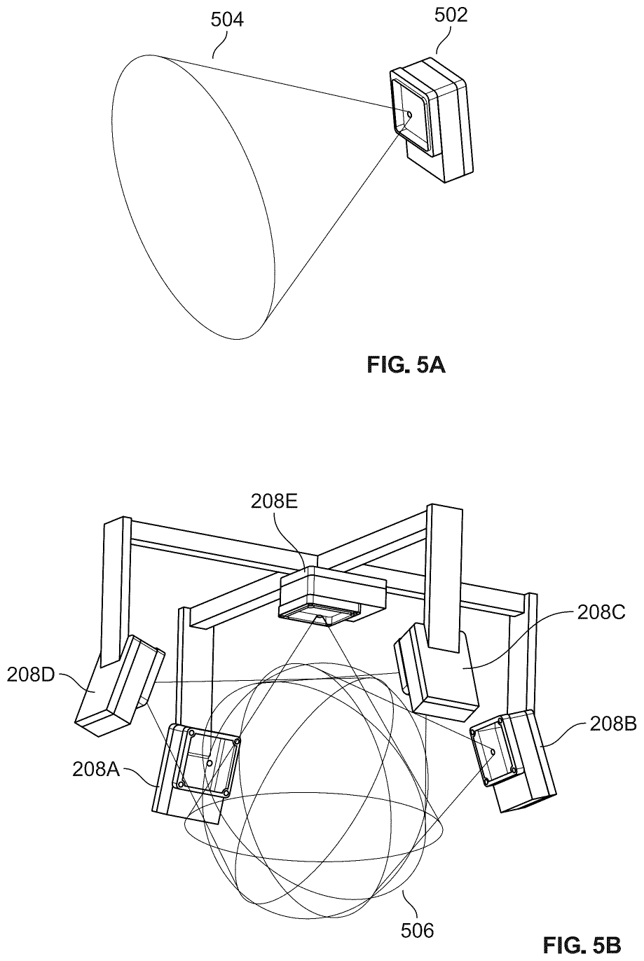

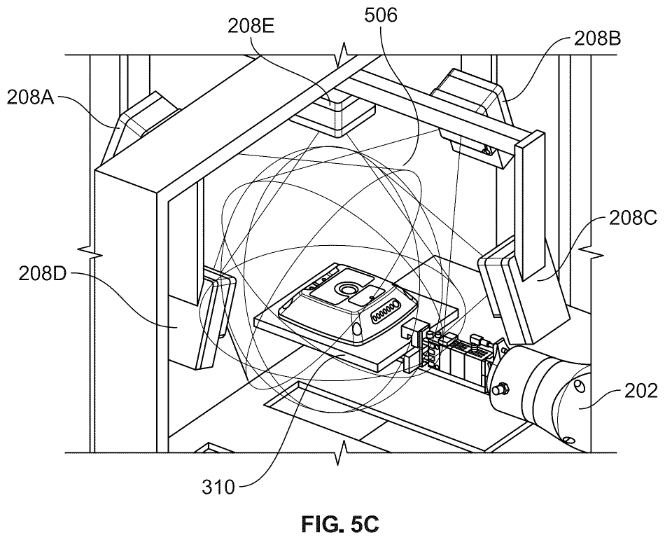

After robotic arm 202 clamps a tray holding one or more objects, the tray is moved so that the one or more objects are in view of plurality of cameras 208A-208E. FIG. 5A shows camera 502 and its visual range 504. FIG. 5B shows plurality of cameras 208A-208E having overlapping visual ranges forming a contiguous inspection field 506. In one embodiment, plurality of cameras 208A-208E are arranged with four cameras (i.e., 208A-208D) placed at angles with respect to a horizon and a certain distance from the center of inspection field 506 to ensure full coverage of the largest object to be inspected from all four sides. One camera (i.e., 208E) of plurality of cameras 208A-208E is located on top to capture a top view of objects located in inspection field 506 as shown in FIG. 5C with tray 310 located within inspection field 506. In one embodiment, the cameras can be utilized so that all cameras can be used simultaneously or in groups of one or more cameras depending on inspection criteria. For trays holding multiple objects, robotic arm 202 can be moved in accordance with programming (e.g., programming entered by a user via HMI 212 with robotic arm 202 being commanded to move via controller 204) to perform an array routine to expose each object separately to plurality of cameras 208A-208E. In one embodiment, an array routine is programming that causes robotic arm 202 to move a tray it is holding in a manner to place each object located on the tray so that each object is located within inspection field 506 for inspection at a different time. Controller 204 identifies failed object(s) on the tray robotic arm 202 is currently holding. In one embodiment, plurality of cameras 208A-208E form a robotic vision system.

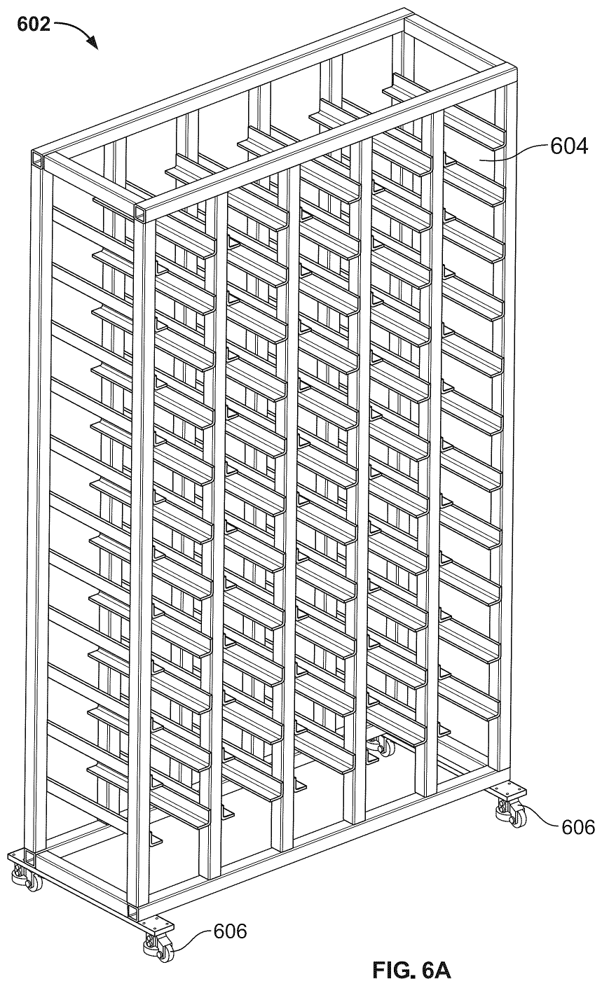

Robotic arm 202 moves trays from incoming mobile shelf rack 104 to inspection field 506 and then to passed inspection mobile shelf rack 104 when objects on the tray pass inspection. FIGS. 6A through 6C show mobile shelf rack 602 which is the same type of mobile shelf rack used for both incoming mobile shelf rack 104 and passed inspection mobile shelf rack 106. FIG. 6A shows mobile shelf rack 602 having a plurality of shelves 604 and casters 606 located at the bottom of mobile shelf rack 602. FIG. 6B shows casters 606 which allow mobile shelf rack 602 to be moved. FIG. 6B also shows how each shelf 604 of shelf rack 602 comprises opposing elongated brackets 608A and 608B each having an L-shaped cross section. FIG. 6C shows how each shelf (such as shelf 604) of mobile shelf rack 602 can hold two trays. FIG. 6C shows shelf 604 holding tray 310 on which large object 312 is located. Shelf 604 is also holding tray 311 on which large object 313 is located.

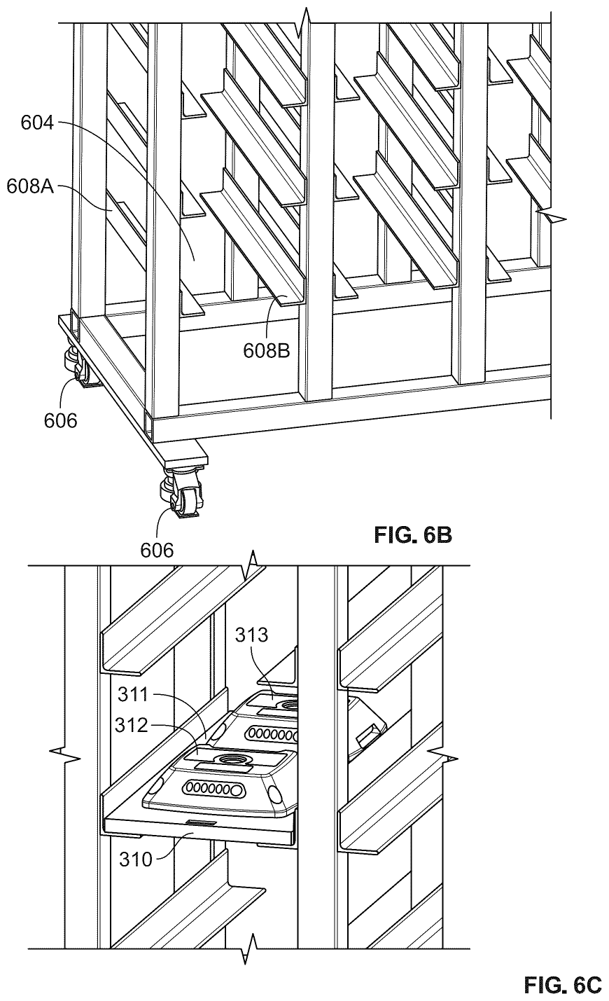

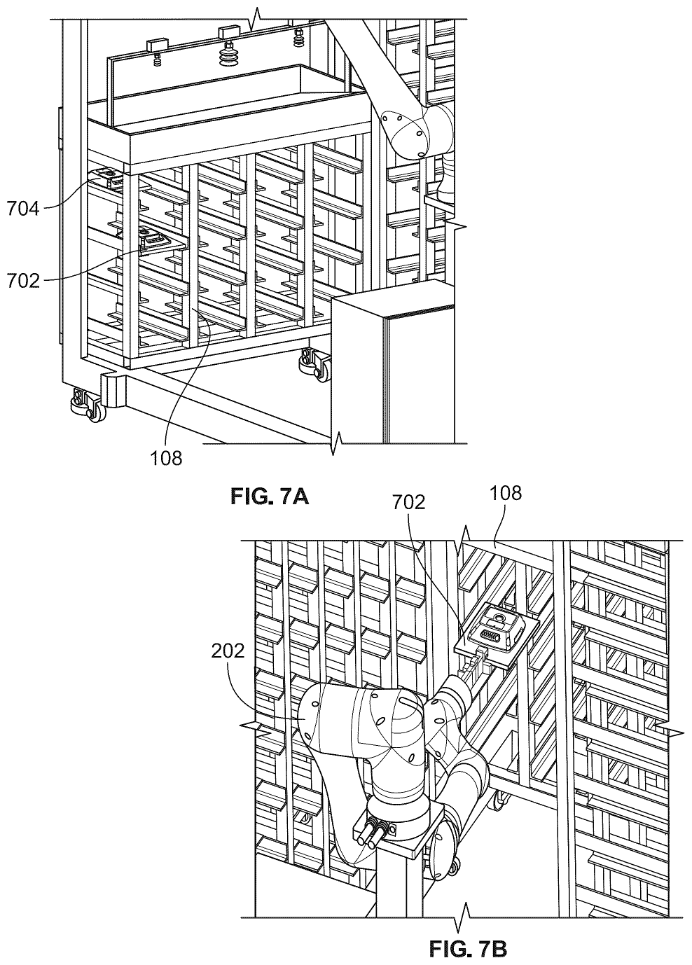

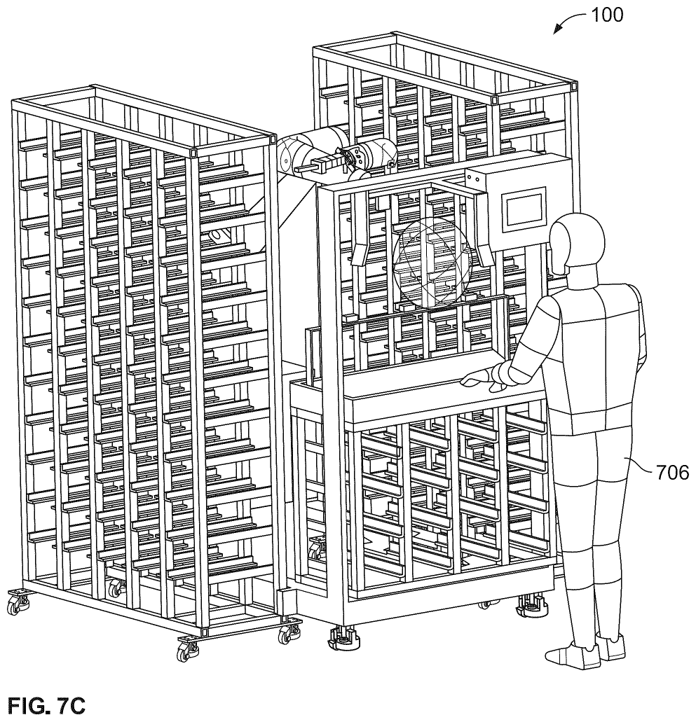

Trays having objects that do not pass inspection are placed on a rejected object shelf. FIGS. 7A-7C show trays located on failed inspection shelves 108. FIG. 7A shows trays 702 and 704 located on shelves of failed inspection shelves 108. In one embodiment, failed inspection shelves 108 is stationary and can hold 32 large object trays. In one embodiment, failed inspection shelves 108 can hold trays two deep. In one embodiment, controller 204 keeps track of trays on shelves. In another embodiment, a presence sensor 304 (shown in FIG. 3A) is used to detect if there is a tray located on a shelf in order to prevent robotic arm 202 from placing more trays on a shelf than the shelf can hold. FIG. 7B shows robotic arm 202 placing tray 702 onto shelf of failed inspection shelves 108. FIG. 7C shows user 706 removing trays from failed inspection shelves 108 after an alarm is sounded indicating that failed inspection shelves 108 is full. In one embodiment, controller 204 keeps track of the number of trays on shelves and produces an audible alarm when controller 204 determines that a shelf rack is full.

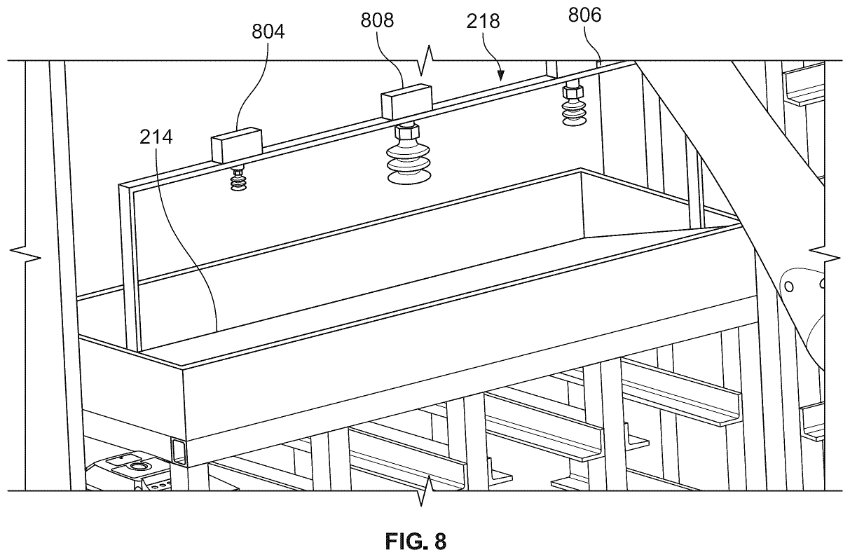

For trays that hold multiple objects, some objects may have passed inspection, and some objects may not have passed inspection. In one embodiment, objects on a tray that have not passed inspection are removed from their tray by object vacuum removal system 218. FIG. 8 shows object vacuum removal system 218 having three vacuum removal cups 804, 806, and 808 located above rejected object tray 214. Although object vacuum removal system 218 is configured to remove small objects from trays, those small objects can be small, medium, or large relative to one another. In one embodiment, vacuum removal cup 804 is sized to remove relatively small objects from a tray, vacuum removal cup 806 is sized to remove relatively medium sized objects from a tray, and vacuum removal cup 808 is sized to remove relatively large objects from a tray.

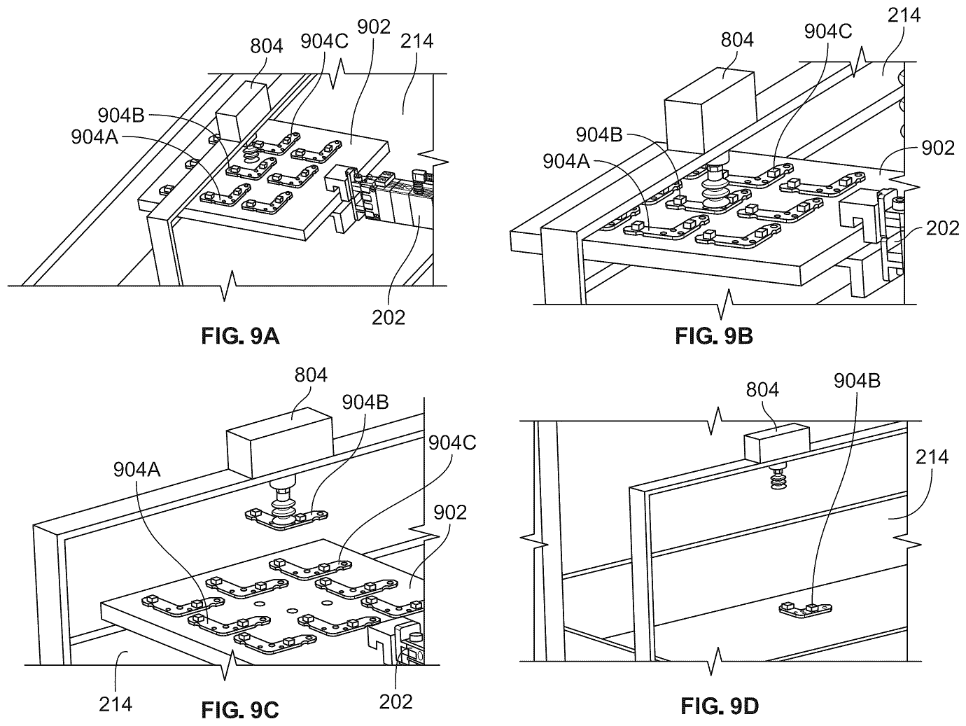

FIGS. 9A through 9D show removal of a relatively small object from a tray by object vacuum removal system 218 (shown in FIG. 8). FIG. 9A shows robotic arm 202 moving tray 902 to a location where relatively small object 904B of a plurality of relatively small objects 904A-904C is located under vacuum removal cup 804. FIG. 9B shows vacuum removal cup 804 engaging relatively small object 904B to lift relatively small object 904B out of tray 902. FIG. 9C shows relatively small object 904B held by vacuum removal cup 804 as robotic arm 202 moves tray 902 away from vacuum removal cup 804 thereby releasing relatively small object 904B from tray 902. FIG. 9D shows robotic arm 202 having moved tray 902 away from vacuum removal cup 804 so that vacuum removal cup can release relatively small object 904B to fall gently into rejected object tray 214. Objects in rejected object tray 214 can be collected by a user for further inspection.

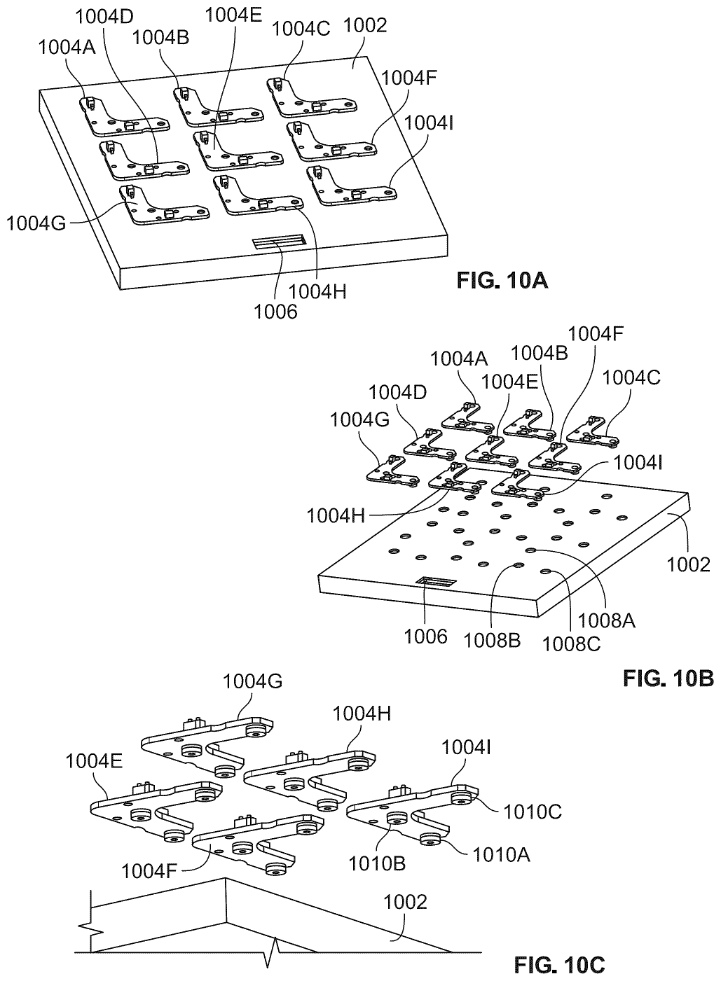

FIGS. 10A through 10C show a tray configured to hold a plurality of small objects. FIG. 10A shows tray 1002 configured to hold small objects 1004A-1004I. FIG. 10A also shows slot 1006 configured to mate with first gripper plate 302A (shown in FIG. 3B). FIGS. 10B and 10C show tray 1002 having a plurality of circular openings for engaging circular protrusions of objects 1004. For clarity, only circular openings 1008A-1008C associated with small part 1004I are identified. Similarly, only circular protrusions 1010A-1010C associated with small part 1004I are identified. Circular protrusions 1010A-1010C are configured to engage its respective one of circular openings 1008A-1008C to removably hold small object 1004I in tray 1002.

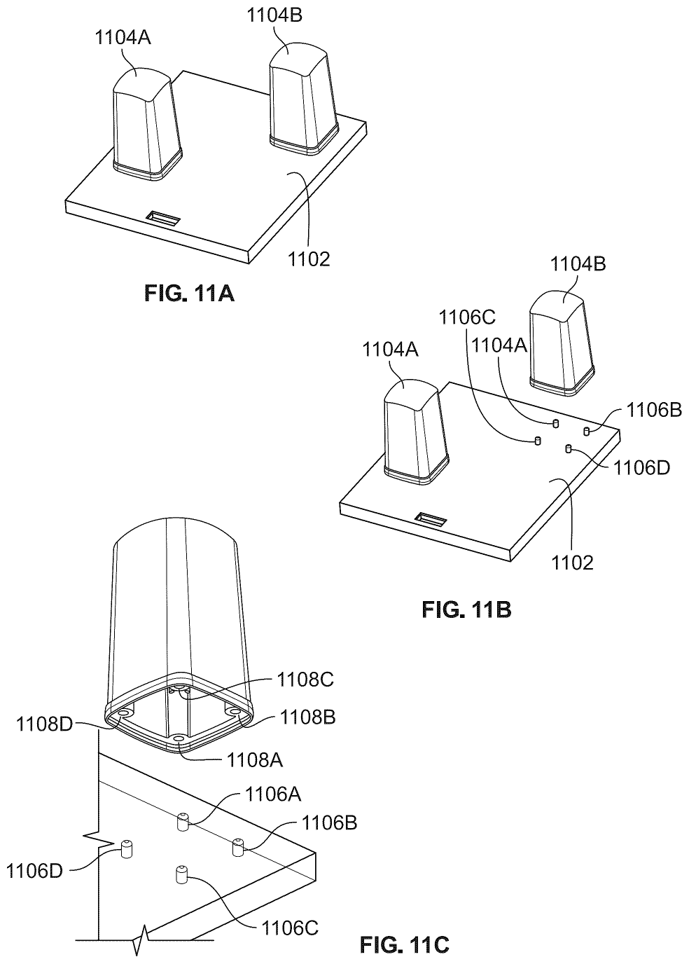

FIGS. 11A through 11C shows a tray configured to hold medium sized objects. FIG. 11A shows two medium sized objects 1104A-B located on tray 1102. FIG. 11B shows a plurality of pegs 1106A-D for engaging respective holes located in medium sized objects 1104. FIG. 11C shows plurality of holes 1108A-D located in medium sized object 1104B.

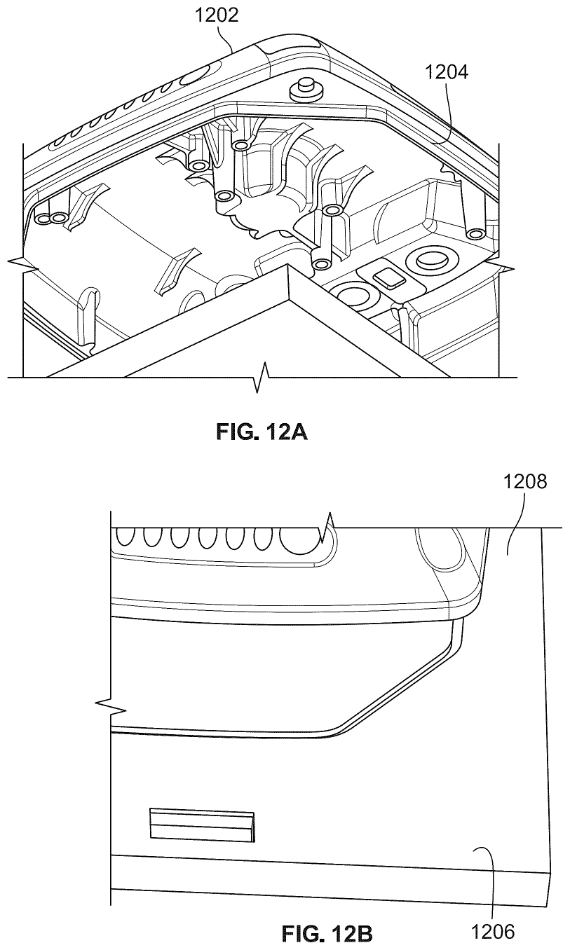

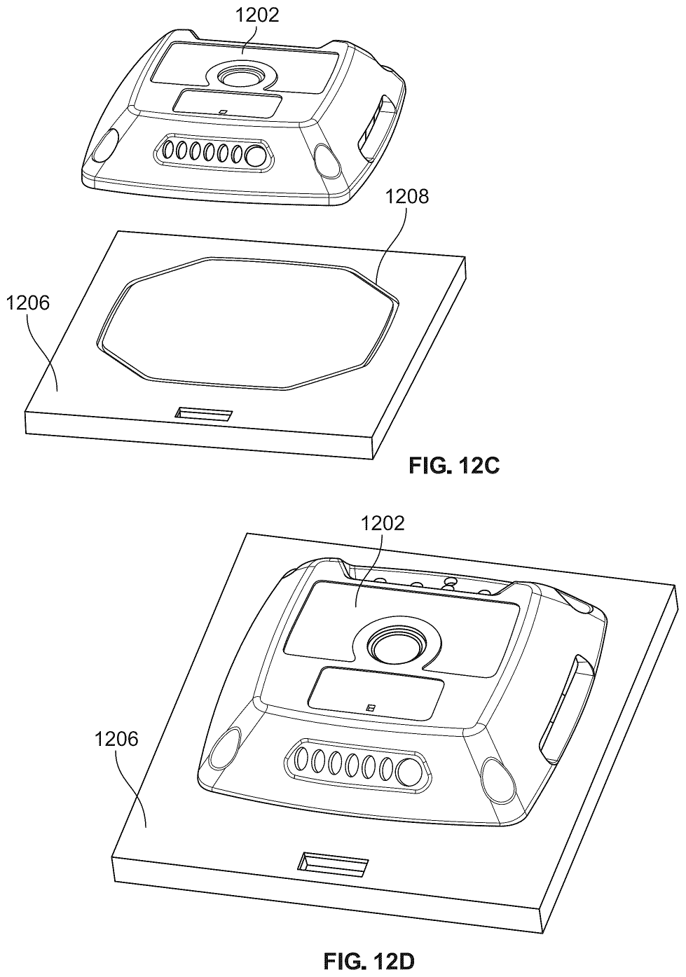

FIGS. 12A through 12D show a tray configured to hold a large object. FIG. 12A shows large object 1202 having tongue 1204. FIG. 12B shows groove 1208 located on tray 1206 configured to mate with tongue 1204. FIG. 12C shows large object 1202 oriented to be lowered onto tray 1206 so that tongue 1204 engages groove 1208 of tray 1206. FIG. 12D shows large object 1202 engaged with tray 1206 via tongue and groove engagement.

The trays described above can be made of plastic that is machined from flat sheets, formed by a 3D printer, or other methods. The size of a tray can be made to hold the largest object to be inspected. As such, each tray can hold multiple smaller parts. Details of each tray can be designed to position the objects precisely and securely so that the objects do not shift or fall during motion of the robotic arm. Trays can be two sided where each side can hold different objects, thus reducing the number of trays needed. Trays can also be configured to hold differently sized objects on one side.

In one embodiment, automated inspection system 100 is utilized as follows. A user places all incoming objects for inspection on designated trays and places the trays on the incoming mobile shelf rack (104 of FIGS. 2A and 2B). The user then moves incoming mobile shelf rack 104 and latches it to robot base 102. The user also moves and latches passed inspection mobile shelf rack 106 to robot base 102. In one embodiment, failed inspection shelves 108 is removeable and a user places failed inspection shelves 108 on frame 210 as shown in FIGS. 2A and 2B. The user scans an object number (e.g., a part number) into the robotic vision system or enters it manually into HMI 212 and initiates an inspection cycle. Automatic inspection system 100 will pick one tray at a time from incoming mobile shelf rack 104 and present the tray (and the objects on the tray) to the plurality of cameras. Robotic arm 102 places trays holding passed objects in passed inspection mobile shelf rack 106. Robotic arm 102 places trays of rejected objects in failed inspection shelves 108. In the case of multiple objects on a single tray, rejected objects can be removed by object vacuum removal system 218 and placed in rejected object tray 214. In cases where rejected objects are removed by object vacuum removal system 218 leaving only acceptable objects on the tray, the rejected objects are removed prior to the tray holding acceptable objects being placed on passed inspection mobile shelf rack 106. Rejected objects can be verified by plurality of cameras 208A-208E. After all objects have been inspected, automatic inspection system 100 will signal a user (by an audible alarm or other type of signal). Automatic inspection system 100 can then generate a report of the inspected objects including data such as number of objects that passed or failed, number of objects inspected, etc.

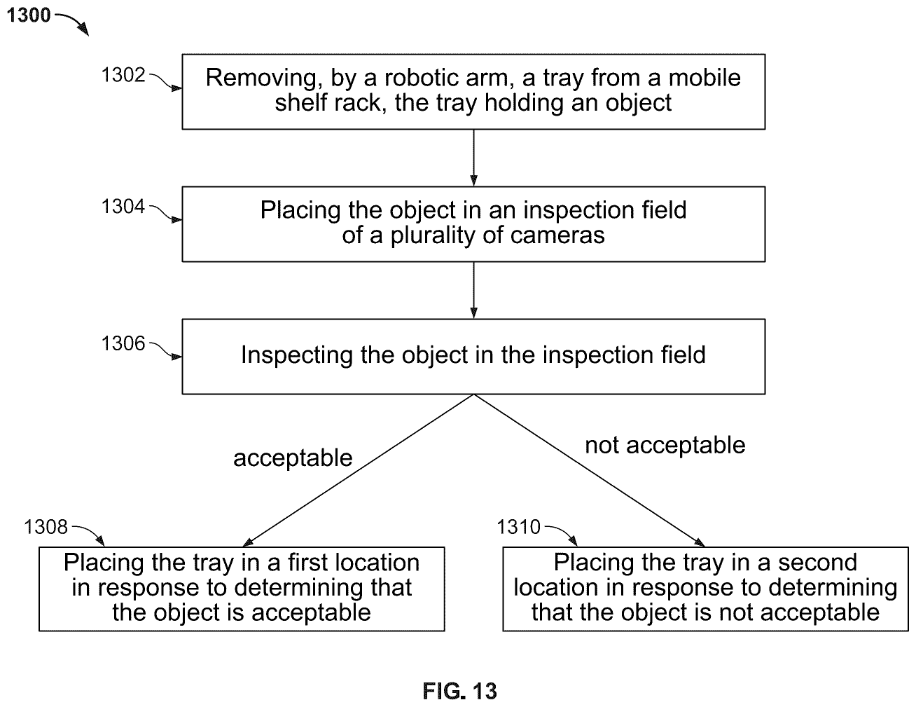

In one embodiment, automatic inspection system is used to perform automatic inspection of parts according to a particular method. FIG. 13 shows method 1300 for automatic inspection of objects according to one embodiment. At step 1302, a robotic arm removes a tray from a mobile shelf rack after gripping the tray using a gripper. At step 1304, the tray is placed in an inspection field of a plurality of cameras. At step 1306, the object in the inspection field is inspected. In one embodiment, the object is inspected by a plurality of cameras capturing images of the object located in the inspection field. For example, five cameras in total can be used with four cameras capturing side views of the object and one camera capturing a top view of the object. At step 1308, the tray is placed in a first location in response to the inspecting determining that the object is acceptable. At step 1310, the tray is placed in a second location in response to the inspecting determining that the object is not acceptable. In one embodiment, the first location is a mobile shelf rack for holding trays holding acceptable objects and the second location is a mobile shelf rack for holding trays holding unacceptable objects. In one embodiment, inspection of objects is performed using artificial intelligence. In one embodiment, the artificial intelligence analyzes the object based on images captured by the plurality of cameras.

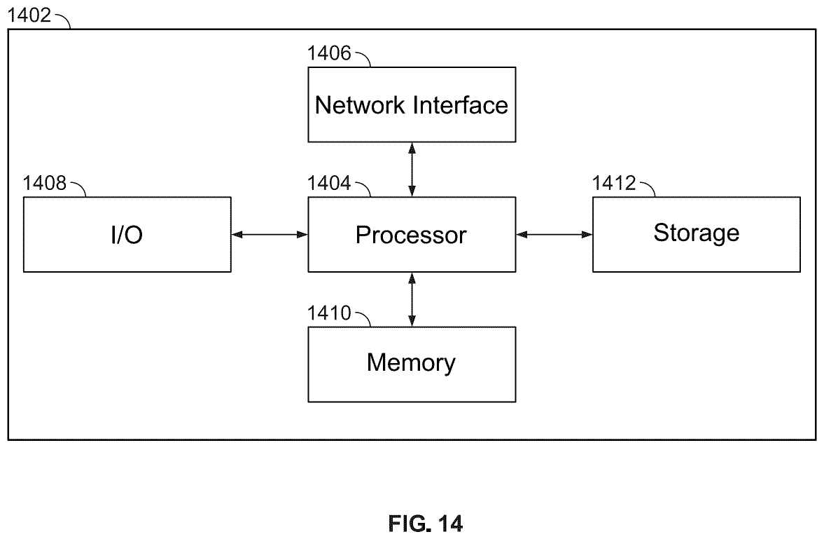

Controller 204 and HMI 21 can be implemented using a computer. A high-level block diagram of such a computer is illustrated in FIG. 14. Computer 1402 contains a processor 1404 which controls the overall operation of the computer 1402 by executing computer program instructions which define such operation. The computer program instructions may be stored in a storage device 1412, or other computer readable medium (e.g., magnetic disk, CD ROM, etc.), and loaded into memory 1410 when execution of the computer program instructions is desired. Thus, the method steps of FIG. 13 as well as other methods and algorithms described herein, can be defined by the computer program instructions stored in the memory 1410 and/or storage 1412 and controlled by the processor 1404 executing the computer program instructions. For example, the computer program instructions can be implemented as computer executable code programmed by one skilled in the art to perform an algorithm defined by the method steps of FIG. 13 as well as other methods and algorithms described herein. Accordingly, by executing the computer program instructions, the processor 1404 executes an algorithm defined by the method steps of FIG. 13 or other methods and algorithms described herein. The computer 1402 also includes one or more network interfaces 1406 for communicating with other devices via a network. The computer 1402 also includes input/output devices 1408 that enable user interaction with the computer 1402 (e.g., display, keyboard, mouse, speakers, buttons, etc.) One skilled in the art will recognize that an implementation of an actual computer could contain other components as well, and that FIG. 14 is a high-level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method comprising:
removing, by a robotic arm mounted to a robot base, a tray from a mobile shelf rack removably attached to the robot base, the tray holding an object;
maneuvering, by the robotic arm, the tray such that the object is placed in an inspection field of a plurality of cameras;
inspecting the object in the inspection field using the plurality of cameras;
placing, by the robotic arm, the tray in a first location in response to the inspecting determining that the object is acceptable; and
placing, by the robotic arm, the tray in a second location in response to the inspecting determining that the object is not acceptable.

2. The method of claim 1, wherein the object is inspected to check one or more of object specifications, tolerances, or blemishes.

3. The method of claim 1, further comprising:
gripping, by a gripper of the robotic arm, the tray.

4. The method of claim 1, wherein the inspecting comprises capturing images of the object in the inspection field using five cameras arranged so that their fields of view form a contiguous inspection field.

5. The method of claim 4 wherein the inspecting comprises capturing a top view of the object located in the inspection field using one of the plurality of cameras located above the inspection field.

6. The method of claim 1, wherein the inspecting comprises capturing side views of the object located in the inspection field using four of the plurality of cameras located to face the sides of the object.

7. The method of claim 1, wherein the placing the tray in the first location comprises placing the tray in a mobile shelf rack for holding trays holding acceptable objects.

8. The method of claim 1, wherein the placing the tray in the second location comprises placing the tray in a mobile shelf rack for holding trays holding unacceptable objects.

9. The method of claim 1, wherein the inspecting the object comprises analyzing the object using artificial intelligence.

10. The method of claim 9, wherein the artificial intelligence analyzes the object based on images captured by the plurality of cameras.

11. The method of claim 1, further comprising removing objects from the tray that are not acceptable and placing the removed objects in a rejected object tray prior to placing the tray in the first location with the acceptable object.

12. An automatic inspection system comprising:
a robot base;
a robotic arm mounted to the robot base and configured to grip and maneuver a tray;
a plurality of cameras;
an incoming mobile shelf rack removably attached to the robot base and configured to hold a plurality of trays;
a controller configured to control the automated inspection system to perform operations comprising:
removing from the incoming mobile shelf rack, by the robotic arm, a first tray;
maneuvering the first tray such that an object on the first tray is in an inspection field of the plurality of cameras;
inspecting the object in the inspection field;
placing, by the robotic arm, the first tray in a first location in response to the inspecting determining that the object is acceptable; and
placing, by the robotic arm, the first tray in a second location in response to the inspecting determining that the object is not acceptable.

13. The automatic inspection system of claim 12, further comprising:
a passed inspection mobile shelf rack for holding a plurality of trays holding objects that have passed inspection,
wherein the first location is the passed inspection mobile shelf rack.

14. The automatic inspection system of claim 12, further comprising:
failed inspection shelves for holding a plurality of trays holding objects that have failed inspection,
wherein the second location is the failed inspection shelves.

15. The automatic inspection system of claim 13, further comprising:
a rejected object tray; and
an object vacuum removal system configured to remove one or more objects in a tray and place the objects in the rejected object tray.

16. The automatic inspection system of claim 15, wherein the controller is configured to cause the object vacuum removal system to remove the one or more objects and place the one or more removed objects in the rejected object tray prior to placing the first tray in a first location.

17. The automatic inspection system of claim 12, wherein the plurality of cameras is arranged so that their fields of view form a contiguous inspection field.

18. The automatic inspection system of claim 12, wherein the controller is configured to inspect the object using artificial intelligence.

19. The automatic inspection system of claim 12, wherein the robotic arm has a gripper configured to grip the first tray.

20. The automatic inspection system of claim 19, wherein the gripper has a jaw configured to engage a slot of a tray.
